(19) United States
(12) Patent Application Publication
(10) Pub. No.: US 2004/0163794 A1
(43) Pub. Date: Aug. 26, 2004

(54) Engine driven by high-pressure gas

(76) Inventor: Masashi Takagi, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/779,580

(22) Filed: Feb. 13, 2004

(30) Foreign Application Priority Data
Feb. 24, 2003 (JP) 2003-046125

(51) Int. Cl. F02B 63/00; F02B 41/00; B60H 3/00; B61D 27/00; F25B 27/00

(52) U.S. Cl. 165/43; 123/2; 123/22; 62/323.1

(57) ABSTRACT

An engine driven by high-pressure gas comprises: a high-pressure gas tank (7) for storing high-pressure gas; a piston (3) displaced when pressure is given from the high-pressure gas tank (7) to the piston (3), the piston (3) composing an expansion chamber (4) in which the high-pressure gas is expanded; and a crank shaft for converting a displacement of the piston (3) into a rotary motion, and fuel is burnt in the expansion chamber (4) when a volume of the expansion chamber (4) is expanded by the high-pressure gas supplied into the expansion chamber (4). Due to the foregoing, the piston (3) is displaced mainly by the pressure of high-pressure gas in the same manner as that of starting the engine, and the combustion of fuel is mainly used to prevent the temperature of gas in the expansion chamber (4) from being decreased.

### BACKGROUND OF THE INVENTION

1. Field of the Invention

The present invention relates to an engine for generating a mechanical output, such as a torque, by utilizing high-pressure gas.

2. Description of the Related Art

In a conventional engine, in addition to suction gas in which fuel and air used for combustion are previously mixed, air stored in a tank, the pressure of which is not less than a predetermined value, is additionally supplied into a cylinder, and then the suction gas sucked into the cylinder is compressed and exploded and a piston is displaced so that a mechanical output can be obtained by utilizing expansion pressure of the combustion gas generated in the process of explosive combustion of fuel.

However, according to the above invention, an output of the engine is increased when a quantity of air sucked into the cylinder is increased.

### SUMMARY OF THE INVENTION

In view of the above points, the present invention has been accomplished. It is an object of the present invention to provide a new engine different from a conventional engine.

In order to accomplish the above object, according to a first aspect of the present invention, there is provided an engine driven by high-pressure gas comprising: a high-pressure gas tank (7) for storing high-pressure gas; a movable member (3) displaced when pressure is given from the high-pressure gas tank (7) to the movable member (3), the movable member (3) composing an expansion chamber (4) in which the high-pressure gas is expanded; a crank means for converting a displacement of the movable member (3) into a rotary motion; and a heating means for heating the high-pressure gas when a volume of the expansion chamber (4) is expanded by the high-pressure gas supplied into the expansion chamber (4).

Due to the foregoing, it is possible to obtain a new engine different from a conventional engine.

According to a second aspect of the present invention, there is provided an engine, driven by high-pressure gas, wherein the heating means heats the high-pressure gas when fuel is supplied into the expansion chamber (4) and the thus supplied fuel is burnt in the expansion chamber (4).

According to a third aspect of the present invention, there is provided an engine, driven by high-pressure gas, wherein a fuel injection port for supplying liquid fuel into the expansion chamber (4) and a high-pressure gas injection port for supplying the high-pressure gas into the expansion chamber (4) are arranged close to each other.

Due to the foregoing, liquid fuel can be atomized into particulates by utilizing an injection force of high-pressure gas without increasing the discharging pressure of a fuel pump.

According to a fourth aspect of the present invention, there is provided an engine driven by high-pressure gas, wherein the high-pressure gas is a compressed fluid containing at least oxygen.

According to a fifth aspect of the present invention, there is provided an engine, driven by high-pressure gas, further comprising an oxidization facilitating device for facilitating oxidization of oxygen supplied into the expansion chamber (4).

According to a sixth aspect of the present invention, there is provided an engine driven by high-pressure gas, further comprising: a discharge port (5) for discharging gas from the expansion chamber (4); and a valve (6) for opening and closing the discharge port (5), wherein fuel is burnt in the expansion chamber (4) under the condition that the gas discharged from the discharge port (5) is sucked and compressed in the expansion chamber (4).

Due to the foregoing, it is possible to burn fuel over a long period of time included in the process of reburning. Therefore, even if a period of time spent for the expansion stroke is reduced, it is possible to burn fuel over a long period of time. Accordingly, a quantity of harmful substance contained in the combustion gas, which could be discharged into the atmospheric air, can be reduced.

Further, as the combustion gas remaining in the exhaust gas pipe is sucked into the cylinder, the temperature in the expansion chamber (4) can be raised to higher than that of a commonly used internal combustion engine in which new gas is sucked and compressed in the cylinder. Accordingly, a quantity of harmful substance contained in the combustion gas, which is discharged into the atmospheric air, can be reduced.

According to a seventh aspect of the present invention, there is provided an engine driven by high-pressure gas, wherein the gas discharged from the discharge port (5) is sucked and then compressed.

Due to the foregoing, the engine structure can be simplified.

According to an eighth aspect of the present invention, there is provided an engine driven by high-pressure gas wherein, after suction of the gas discharged from the discharge port (5) was started, fuel is injected into the expansion chamber (4).

According to a ninth aspect of the present invention, there is provided an engine driven by high-pressure gas wherein, after fuel is injected into the expansion chamber (4), the high-pressure gas is supplied into the expansion chamber (4).

According to a tenth aspect of the present invention, there is provided an engine, driven by high-pressure gas, further comprising a pressure control means for controlling pressure of the high-pressure gas supplied into the expansion chamber (4), wherein the pressure control means controls the output of the engine.

Due to the foregoing, different from the commonly used internal combustion engine in which an intensity of the engine output is adjusted by increasing and decreasing a quantity of fuel supplied to the combustion chamber, fuel can be burnt over a long period of time irrespective of the engine speed. Accordingly, the quantity of harmful substance contained in the combustion gas, which is discharged into the atmospheric air, can be reduced irrespective of the engine speed.

According to an eleventh aspect of the present invention, there is provided an engine, driven by high-pressure gas, further comprising a control device for controlling the operation of the pressure control means and the heating means, wherein the control device stops the heating means at the time of starting the engine and displaces the movable member by the pressure of the high-pressure gas.

Due to the foregoing, the engine can be set in motion by only the pressure of high-pressure gas without burning fuel. Therefore, it is possible to prevent the combustion gas containing a relatively large quantity of harmful substance from being discharged into the atmospheric air.

According to a twelfth aspect of the present invention, there is provided an engine driven by high-pressure gas, further comprising a high-pressure gas supplying means (10) for supplying high-pressure gas into the high-pressure gas tank (7) by the power of the crank means when the pressure in the high-pressure gas tank (7) is decreased to a value not more than a predetermined value.

According to a thirteenth aspect of the present invention, there is provided an air conditioner applied to a movable body moving by the power of the engine of the twelfth aspect, wherein air blown out into a compartment is heated when high-pressure gas discharged from the high-pressure gas supply means (10) is introduced into the heater (12), and high-pressure gas, from which heat has been emitted, is supplied into the high-pressure gas tank (7) or to the engine.

According to a fourteenth aspect of the present invention, there is provided an air conditioner applied to a movable body moving by a power source of the engine of the twelfth aspect wherein, when the engine is operated, the pressure of high-pressure gas discharged from the high-pressure gas supply means (10) is reduced and then introduced into the cooler (13) so as to cool air blown out into a compartment, and when the engine is stopped, the pressure of high-pressure gas supplied from the high-pressure gas tank (7) is reduced and then introduced into the cooler (13) so as to cool air blown out into the compartment, and gas flowed out from the cooler (13) is supplied to the engine.

Due to the foregoing, it is possible to conduct a refrigerating operation without deteriorating the accelerating capacity of a vehicle. Further, even when the engine is stopped, the refrigerating operation can be executed.

Further, it is possible to reduce an intensity of noise generated when high-pressure gas is discharged into the atmospheric air.

According to a fifteenth aspect of the present invention, there is provided an engine, driven by high-pressure gas, wherein the expansion chamber is arranged in an engine body, the expansion chamber includes a piston (3) composing the movable member, a cylinder (2) for accommodating the piston and a gas discharge port connected to an exhaust pipe, the high-pressure gas tank (7) stores gas, the pressure of which is maintained at a value higher than the pressure in the expansion chamber in the case where a volume of the expansion chamber (4) is reduced to the minimum, the high-pressure gas tank (7) is connected to a gas injection device via a pipe, the engine driven by high-pressure gas further comprising: a valve (6) for opening and closing the discharge port of the expansion chamber; a fuel tank (9); and a fuel injection device for injecting fuel from the fuel tank (9) into the expansion chamber (4), wherein the engine body is started by the pressure of high-pressure gas stored in the high-pressure gas tank (7), and the gas remaining in the exhaust pipe is repeatedly sucked into and compressed by the engine body.

According to a sixteenth aspect of the present invention, there is provided an engine, driven by high-pressure gas, wherein the catalyst (11) is arranged in the exhaust pipe, after the engine body is started in which the temperature of the catalyst (11) reaches an activating temperature of the catalyst, fuel is injected into the expansion chamber, fuel gas in the expansion chamber is compressed, after the gas remaining in the exhaust pipe is sucked, the process is transferred to the compression stroke, when the piston comes to a position close to the upper dead point, high-pressure gas is supplied into the combustion chamber at the pressure of the high-pressure gas tank which is higher than the pressure in the expansion chamber, and fuel in the expansion chamber is ignited and burnt so as to execute the expansion stroke.

According to a seventeenth aspect of the present invention, there is provided an engine driven by high-pressure gas, wherein the piston successively repeats at least an expansion stroke in which expansion is conducted, an exhaust stroke, a suction stroke, a compression stroke and the expansion stroke which are conducted in the expansion chamber.

According to an eighteenth aspect of the present invention, there is provided an engine driven by high-pressure gas, wherein a volume of the expansion chamber (4) is expanded by the pressure of high-pressure gas injected by the gas injection device in the expansion stroke, a volume of the expansion chamber (4) is reduced and the remaining gas is discharged from the discharge port (5) into the exhaust pipe in the exhaust stroke, the remaining gas remaining in the exhaust pipe is sucked from the discharge port (5) in the suction stroke, and the volume of the expansion chamber (4) is reduced and gas, which is sucked or injected into the expansion chamber, is compressed in the compression stroke.

According to a nineteenth aspect of the present invention, there is provided an engine, driven by high-pressure gas wherein, at the time of operation of the engine conducted after the engine was started, fuel is injected in the middle of the suction stroke or fuel is injected after the process was transferred to the compression stroke, the expansion stroke is composed of an expansion ignition combustion stroke in which high-pressure gas is injected into the expansion chamber by the gas injection device and fuel injected is ignited and burnt, the exhaust stroke is composed of a stroke in which a volume of the expansion chamber (4) is reduced and the remaining gas is discharged from the discharge port (5) into the exhaust pipe, the suction stroke is composed of a suction stroke in which the remaining gas remaining in the exhaust pipe is sucked from the discharge port (5), and the compression stroke is composed of a compression stroke in which gas sucked from or injected into the expansion chamber, the volume of which is reduced, is compressed.

Due to the foregoing, in the suction stroke in which the remaining gas is sucked into the cylinder, even when fuel is injected into the cylinder in the middle of the suction stroke, no spontaneous ignition is caused because the concentration of oxygen is low. Fuel injection may be conducted in the compression stroke. Next, high-pressure gas is injected and expanded, and the fuel gas is ignited and burnt.

According to a twentieth aspect of the present invention, there is provided an engine driven by high-pressure gas, further comprising a compressor (10) for sucking, compressing and discharging air into a high-pressure gas tank when power is given to the compressor (10) by the engine body, wherein kinetic energy of the vehicle is recovered as pressure energy of high-pressure gas in the case of running on a downward slope or applying the brakes in such a manner that torque of the crank shaft of the engine is transmitted to the compressor (10) under the condition that the discharge port (5) is closed and air pressurized by the compressor (10) is charged into the high-pressure gas tank.

According to a twenty-first aspect of the present invention, there is provided an engine driven by high-pressure gas, wherein an output of the engine is adjusted when the pressure of high-pressure gas supplied into the expansion chamber (4) is adjusted.

According to a twenty-second aspect of the present invention, there is provided an engine driven by high-pressure gas, further comprising: a compressor (10) for sucking, compressing and discharging air into a high-pressure gas tank so as to charge air into the high-pressure gas tank when power is given to the compressor 10 by the engine body; and a heat exchanger for exchanging heat between the high-pressure gas discharged from the compressor (10) and the atmospheric air so as to cool the high-pressure gas to a temperature close to the outside air temperature, wherein high-pressure gas, the temperature of which has been cooled to a temperature approximate to the outside air temperature by the radiator (11), is supplied into the high-pressure gas tank (7) when the high-pressure gas is charged into the high-pressure gas tank (7).

According to a twenty-third aspect of the present invention, there is provided an engine driven by high-pressure gas, further comprising a compressor (10) for sucking, compressing and discharging air into a high-pressure gas tank so as to charge air into the high-pressure gas tank when power is given to the compressor (10) by the engine body, wherein the heater is heated by the heat of high-pressure gas which is heated by the compressor (10) and heat exchange is conducted between the heater and the air blown out into the passenger compartment of the vehicle, on which the engine body is mounted, so as to heat the air blown out into the passenger compartment.

Incidentally, the reference numerals, in parentheses, to denote the above means, are intended to show the relationship to the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

FIG. 1 is a schematic illustration showing a model of a vehicle in which an engine of the first embodiment of the present invention is used.

FIG. 2 is a schematic illustration showing a model of a vehicle in which an engine of the second embodiment of the present invention is used.

FIG. 3 is a schematic illustration showing a model of a vehicle in which an engine of the third embodiment of the present invention is used.

### DESCRIPTION OF PREFERRED EMBODIMENTS

First, the first embodiment of the present invention will be explained below.

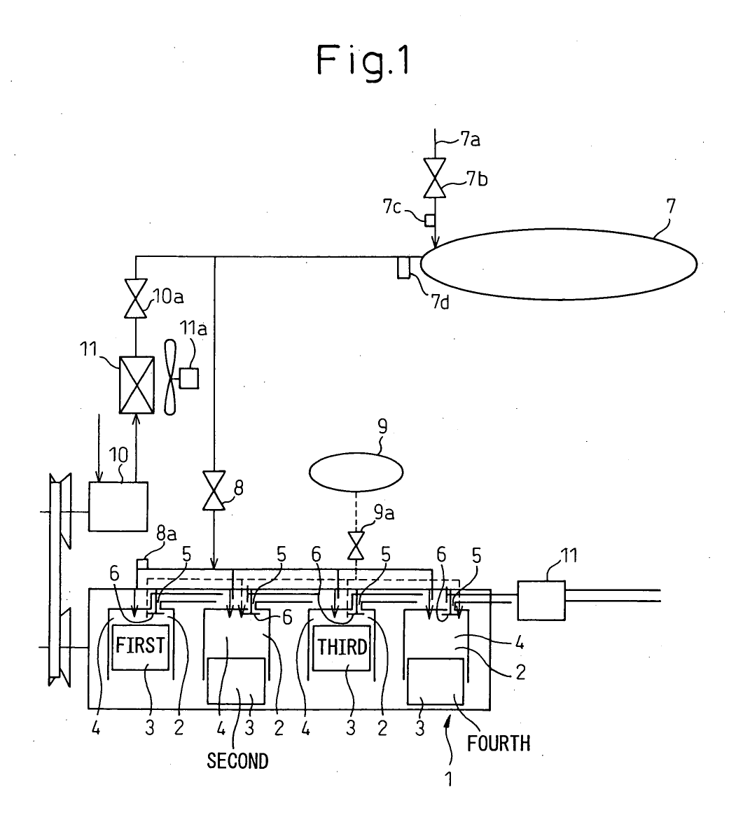

In this embodiment, an engine according to the present invention is applied to the drive source for vehicle use. FIG. 1 is a schematic illustration of a vehicle in which the engine of the present embodiment is used.

The engine body 1 includes: a piston 3 which is a movable member reciprocating in the cylinder 2 formed into a cylindrical space; a crank shaft (not shown) for converting a reciprocating motion of the piston 3 into a rotary motion; and a valve 6 for opening and closing a gas discharge port 5 provided in the expansion chamber 4 composed of the piston 3 and the cylinder 2.

In this connection, in this embodiment, the cylinder block composing the cylinder 2, the cylinder head, in which the discharge port 5 is formed, for closing one end side of the expansion chamber 4 and the valve 6 are made of metal. The valve 6 opens and closes the discharge port 5 via the mechanism such as a tuning belt and gears, synchronizing with the rotary angle of the crank shaft.

The high-pressure gas tank 7 is a tank means for storing high-pressure gas. In this high-pressure gas tank 7, gas (air in this embodiment) is stored, the pressure of which is maintained to be higher than the pressure in the expansion chamber 4 in the case where a volume of the expansion chamber 4 is reduced to the minimum.

In this connection, in principle, high-pressure gas stored in the high-pressure gas tank 7 is supplied by a gas pump arranged outside the vehicle, for example, by a gas pump arranged in a high-pressure gas station. The gas supply pipe 7a connects the high-pressure gas supply port to the high-pressure gas tank 7.

This gas supply pipe 7a is attached with a check valve 7b for preventing high-pressure gas in the high-pressure tank 7 from being emitted into the atmospheric air from the high-pressure gas supply port. This gas supply pipe 7a is also attached with a pressure sensor 7c for detecting a quantity of high-pressure gas in the high-pressure gas tank 7, that is, for detecting the pressure in the high-pressure gas tank 7.

The activating device 7d is an oxidization facilitating means for facilitating the oxidization of oxygen contained in air supplied to the expansion chamber 4. In this embodiment, oxygen is changed into ozone by irradiating ultraviolet rays onto high-pressure gas so that the oxidizing reaction of oxygen can be facilitated.

In the cylinder head, the gas injection device is provided, which is used for injecting and supplying high-pressure gas, which is stored in the high-pressure gas tank 7, into the expansion chamber 4. The high-pressure gas supply valve 8 is arranged in the pipe connecting the high-pressure gas tank 7 to the gas injection device so as to control the supply of high-pressure gas to the injection device. Further, the high-pressure gas supply valve 8 adjusts the pressure of high-pressure gas supplied into the expansion chamber 4.

In this connection, the pressure sensor 8a is a pressure detecting means for detecting the pressure of high-pressure gas supplied into the expansion chamber 4.

The fuel tank 9 stores fuel to be supplied into the expansion chamber 4. In this embodiment, the fuel tank 9 stores fuel such as propane gas or hydrogen gas, which is kept in the state of gas at the normal temperature, under the pressurized state. Between the fuel tank 9 and the fuel injection device for injecting and supplying fuel into the expansion chamber 4, the fuel supply valve 9a for adjusting the pressure of fuel to be supplied to the fuel injection device is provided.

The compressor 10 is an air pump for sucking and compressing air when power is supplied to the compressor 10 from the engine body 1 (crank shaft) via a power transmission device composed of a V-belt, electromagnetic clutch and so forth capable of intermittently transmitting power. The discharge side of this compressor 10 is communicated with the high-pressure gas tank 7 via the opening and closing valve 10a.

The radiator 11 is a heat exchanger for cooling high-pressure gas when heat exchange is conducted between the high-pressure gas discharged from the compressor 10 and the atmospheric air. The fan 11a blows a cooling wind onto the radiator 11. In this connection, the electromagnetic clutch, the fuel injection device, the valves 9a, 10 and the blower 11a are controlled by the electronic control unit (ECU).

Each discharge port 5 is connected to a discharge pipe which collects the gas discharged from each discharge port 5 and guides the gas to the catalyst 11. After the gas flows out from the catalyst 11, it passes in the muffler so that the gas discharging noise can be reduced. After that, the gas is discharged into the atmospheric air.

Next, the operation and characteristic of the engine of the present embodiment will be described as follows. In this connection, the engine of the present embodiment is a four cylinder engine having four cylinders 2 (expansion chambers 4). The four expansion chambers 4 are referred to as a first expansion chamber 4, a second expansion chamber 4, a third expansion chamber 4 and a fourth expansion chamber 4 which are arranged from the right to the left in order in FIG. 1.

1. Start of Operation

Under the condition that the valves 9a, 10a are closed, high-pressure gas is successively injected in the order of the first expansion chamber 4→the fourth expansion chamber 4→the third expansion chamber 4→the second expansion chamber 4.

Due to the foregoing, for example, when the piston 3 in the first expansion chamber 4 is displaced by the pressure of high-pressure gas in a direction in which a volume of the expansion chamber 4 is expanded (This state will be referred to as an expansion stroke hereinafter.), the piston 3 in the third expansion chamber 4 is forcibly displaced by the crank shaft in a direction in which a volume of the expansion chamber 4 is expanded, so that the gas remaining in the exhaust gas pipe is sucked from the discharge port 5 into the expansion chamber 4 (This state is referred to as a suction stroke hereinafter.).

At the same time, the piston 3 in the second expansion chamber 4 and the piston 3 in the fourth expansion chamber 4 are respectively displaced in a direction in which a volume is reduced. Therefore, the piston 3 in the second expansion chamber 4 starts discharging the high-pressure gas, which remains in the expansion chamber 4, from the discharge port 5 into the exhaust pipe (This state is referred to as an exhaust stroke hereinafter.). The piston 3 in the fourth expansion chamber 4 starts compressing the remaining gas which is sucked or injected into the expansion chamber 4 (This state is referred to as a compression stroke hereinafter.).

That is, when the pressure of high-pressure gas is received by the piston, the crank shaft obtains power from the piston 3, which is in the expansion stroke, and while the crank shaft is outputting torque, it drives the other pistons 3 and the valves 6. Therefore, in the expansion chamber 4, the strokes are conducted in the order of expansion stroke→exhaust stroke→suction stroke→compression stroke→expansion stroke.

The above operation can be enumerated as a time series as follows.

(High-Pressure Gas is Injected into the First Expansion Chamber.)

The first is an expansion stroke by the pressure of high-pressure gas. The next is an exhaust stroke.

The second is an exhaust stroke for reducing a volume and discharging the remaining gas from the discharge port 5 into the exhaust pipe. The next is a suction stroke.

The third is a suction stroke for sucking the remaining gas in the exhaust gas pipe from the discharge port 5. The next is a compression stroke.

The fourth is a compression stroke for compressing the remaining gas, the volume of which is reduced, sucked or injected into the expansion chamber. The next is an expansion stroke.

(High-Pressure Gas is Injected into the Fourth Expansion Chamber.)

The first after the expansion stroke is an exhaust stroke. The next is a suction stroke.

The second after the exhaust stroke is a suction stroke. The next is a compression stroke.

The third after the suction stroke is a compression stroke. The next is an expansion stroke.

The fourth after the compression stroke is an expansion stroke. The next is an exhaust stroke.

(High-Pressure Gas is Injected into the Third Expansion Chamber.)

The first after the exhaust stroke is a suction stroke. The next is a compression stroke.

The second after the suction stroke is a compression stroke. The next is an expansion stroke.

The third after the compression stroke is an expansion stroke. The next is an exhaust stroke.

The fourth after the expansion stroke is an exhaust stroke. The next is a suction stroke.

(High-Pressure Gas is Injected into the Second Expansion Chamber.)

The first after the suction stroke is a compression stroke.

The second after the compression stroke is an expansion stroke.

The third after the expansion stroke is an exhaust stroke.

The fourth after the exhaust stroke is a suction stroke.

2. Normal Operation

At the time of starting the engine, the engine body 10 is operated by utilizing the pressure of high-pressure gas stored in the high-pressure gas tank 7, and the remaining gas in the exhaust pipe is repeatedly sucked and compressed. Therefore, the temperature of the remaining gas, in the exhaust pipe and the catalyst 11, is gradually raised.

When the temperature of the catalyst 11 is raised to a value not less than the activating temperature of the catalyst, fuel is injected into the expansion chamber 4 which is in the middle of the suction stroke or transferred into the compression stroke, so that fuel gas in the expansion chamber 4 is compressed and the temperature is raised.

In this embodiment, as the remaining gas in the exhaust pipe is sucked and the process is transferred into the compression stroke, the temperature in the expansion chamber 4 rises higher than that a commonly used internal combustion engine in which new gas is sucked and compressed. Further, as the remaining gas in the exhaust pipe is sucked and compressed, the concentration of oxygen in the expansion chamber 4 is so low that no spontaneous ignition is caused even if the temperature in the expansion chamber 4 is raised, which is unlike a Diesel engine.

When the piston 3, which is in the compression stroke, comes close to the upper dead point, high-pressure gas, the pressure of which is higher than the pressure in the expansion chamber 4, is supplied into the expansion chamber 4, and fuel in the expansion chamber 4 is ignited and burnt by the ignition device such as a spark plug, and the process is transferred into the expansion stroke.

At this time, in the same manner as that of starting the engine, the piston 3 is displaced mainly by the pressure of high-pressure gas, and fuel is burnt mainly to prevent the temperature of gas in the expansion chamber 4 from being decreased.

Further, the combustion gas generated when fuel was burnt is once discharged into the exhaust pipe in the exhaust stroke, however, in the suction stroke, the combustion gas is sucked again into the expansion chamber 4 and compressed and then burnt again in the expansion stroke together with fuel and high-pressure gas newly supplied. Therefore, according to the present embodiment, fuel can be burnt over a long period of time included in the time of reburning.

Accordingly, a quantity of fuel necessary for ignition (firing) can be reduced as compared with a commonly used internal combustion engine in which fuel is exploded and burnt in a short period of time. Further, even when the capacity of the activating device 7d is low, perfect combustion of fuel can be ensured.

In the process of combustion, fuel is mainly consumed for preventing the temperature of gas in the expansion chamber 4 from decreasing. Therefore, it is unnecessary to burn and explode the fuel in a short period of time. Accordingly, it is possible to lower the temperature in the expansion chamber 4 in the expansion stroke, and further the discharged gas is sucked and burnt. Therefore, a quantity of carbon dioxide in the expansion chamber 4 is larger than that a commonly used internal combustion engine, and nitrogen oxide is seldom generated in the process of combustion.

In the stroke of expansion, compared with the temperature in the expansion chamber of a commonly used internal combustion engine, the temperature in the expansion chamber 4 can be lowered. Therefore, the heat resistant strength of portions such as a cylinder block, cylinder head and valve 6, which are directly exposed to the combustion gas, can be lowered as compared with the commonly used internal combustion engine.

Accordingly, when the heat resistant strength and the cooling capacity of portions such as a cylinder block, cylinder head and valve 6, which are directly exposed to the combustion gas, are lowered, the manufacturing cost can be reduced. At the same time, the deformation caused by thermal stress can be reduced. Therefore, the reliability and durability of the engine can be enhanced, and the air-tightness between the piston 3 and the inner wall of the cylinder is enhanced. Accordingly, the engine efficiency can be enhanced.

According to the present embodiment, as described before, fuel can be burnt, over a long period of time being included in the time of reburning. Therefore, even when the engine speed is increased and a period of time spent for the expansion stroke is reduced, fuel can be burnt, over a long period of time, and a quantity of harmful substance contained in the combustion gas, which is finally discharged into the atmospheric air, can be reduced irrespective of the engine speed. Accordingly, the catalyst 11 can be downsized, and further the temperature of the catalyst 11 can be quickly raised to the activating temperature.

At the time of starting the engine, it is possible to start the engine only by the pressure of high-pressure gas without burning fuel. Therefore, it is possible to prevent the combustion gas from being discharged into the atmospheric air before the catalyst 11 is activated.

In this connection, an output of the engine is adjusted when the pressure of high-pressure gas supplied into the expansion chamber 4 is adjusted. Therefore, different from a conventional internal combustion engine in which an output of the engine is adjusted by increasing and decreasing a quantity of fuel supplied into the combustion chamber, fuel can be burnt, over a long period of time irrespective of the engine speed. Therefore, a quantity of harmful substance contained in the combustion gas, which is finally discharged into the atmospheric air, can be reduced irrespective of the engine speed.

At the time of running on a downward slope or applying the brakes, kinetic energy of the vehicle is recovered as pressure energy of high-pressure gas as follows. Under the condition that the discharge port 5 is closed and the operation of the valve 6 is stopped, the electromagnetic clutch is operated so that torque of the crank shaft is transmitted to the compressor 10, and air pressurized by the compressor 10 is charged into the high-pressure gas tank 7.

At this time, high-pressure gas (high-pressure air), which has been cooled to a temperature corresponding to the outside air temperature by the radiator 11, is supplied to the high-pressure gas tank 7. Therefore, the density of energy stored in the high-pressure gas tank 7 can be increased.

Next, the second embodiment will be explained below. According to this embodiment, the air conditioning function capable of heating and refrigerating is added to the vehicle on which the engine of the first embodiment is mounted.

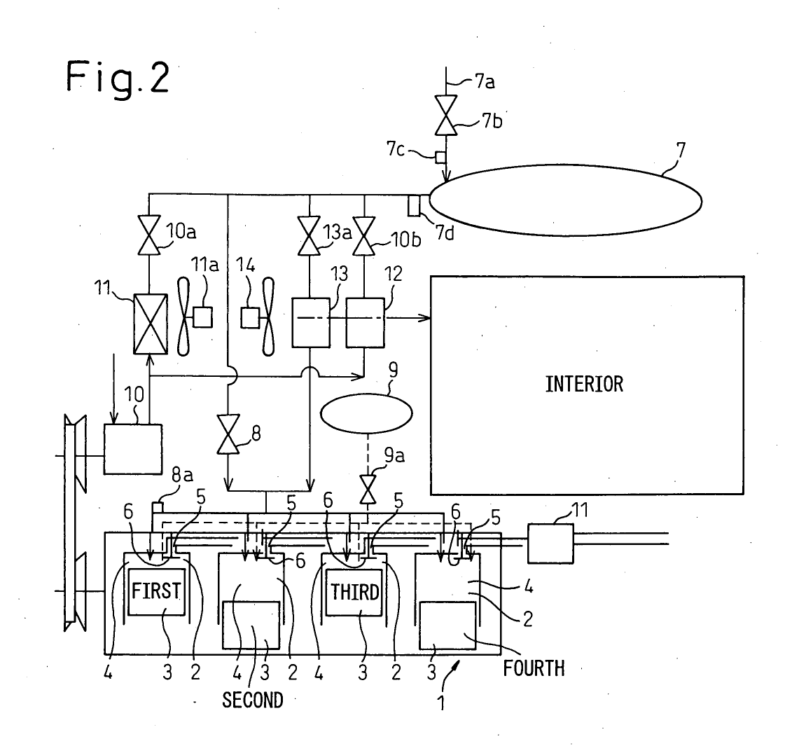

Specifically, as shown in FIG. 2, the air conditioner includes: a heater 12 for heating air, which is blown out into the passenger compartment, by high-pressure gas heated by the compressor 10; a cooler 13 for exchanging heat between the low temperature gas, which is generated when the pressure of high-pressure gas is reduced, and the air blown out into the passenger compartment; and a blower 14 for blowing air into the passenger compartment.

In this connection, the opening and closing valve 10b controls a flow of high-pressure gas flowing into the heater 12, and the pressure reducing device 13a reduces the pressure of high-pressure gas flowing into the cooler 13.

When the heater 12 is operated, the opening and closing valve 10a is closed and the high-pressure gas discharged from the compressor 10 is introduced into the heater 12, and the high-pressure gas, the heat emission of which has been completed, is supplied to the high-pressure tank 7 or the engine body 1.

In the case where the cooler 13 is operated when the engine is accelerated or stopped, the pressure of the high-pressure gas supplied from the high-pressure gas tank 7 is reduced by the pressure reducing device 13a to a value corresponding to a predetermined temperature and introduced to the cooler 13 so as to cool the air blowing out into the passenger compartment, and the gas flowing out from the cooler 13 is supplied to the engine body 1.

On the other hand, in the case where the cooler 13 is operated when the engine is running, the high-pressure gas generated by the compressor 10 is cooled by the radiator 11, and the pressure of the thus cooled high-pressure gas is reduced by the pressure reducing device 13a to a value corresponding to a predetermined temperature and introduced to the cooler 13 so that the air blown out into the passenger compartment is cooled, and the gas, which has flowed out from the cooler 13, is supplied to the engine body 1.

In this connection, of course, the pressure of gas, which has flowed out from the cooler 13, is the same as or higher than the pressure after the adjustment of pressure conducted by the high-pressure gas supply valve 8.

Due to the foregoing, refrigerating and heating can be conducted by utilizing the compressor 10 used for recovering energy.

In the refrigerating operation, it is possible to change over between two cases. One is a case in which the high-pressure gas generated by the compressor 10 is used, and the other is a case in which the high-pressure gas stored in the high-pressure gas tank 7 is used. Accordingly, it is possible to conduct a refrigerating operation without deteriorating the accelerating capacity. Further, even when the engine is stopped, it is possible to conduct a refrigerating operation.

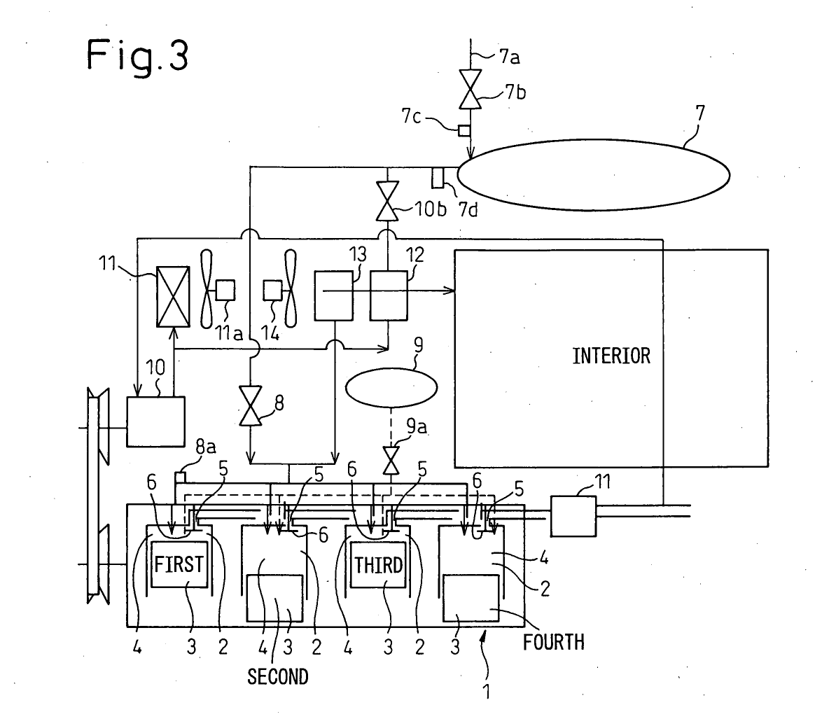

Next, the third embodiment will be explained below. In the first and the second embodiment, the combustion gas remaining in the exhaust pipe is sucked again from the discharge port 5 into the expansion chamber 4. However, in this embodiment, as shown in FIG. 3, the combustion gas, which has flowed out from the catalyst 11, is sucked by the compressor 10 and stored in the high-pressure tank 7 so that the combustion gas can be made to be a high-pressure gas. The thus compressed combustion gas is used, and the gas remaining in the exhaust pipe is not sucked in the suction stroke but air containing oxygen is sucked.

When the engine is started for the first time, no combustion gas is provided for supplying into the high-pressure gas tank 7. Therefore, an inert gas such as carbon dioxide or nitrogen gas is charged.

Finally, another embodiment will be explained below. In the above embodiment, fuel, which is in a gaseous state at the normal temperature, is employed. However, fuel, which is in a liquid state at the normal temperature, may be employed, and further a fuel injection port of the fuel injection device and a gas injection port of the gas injection device may be arranged close to each other.

Due to the foregoing, liquid fuel can be atomized by utilizing an injecting force of high-pressure gas without increasing the discharging pressure of the fuel pump.

In the above embodiment, the present invention is applied to a vehicle. However, it should be noted that the present invention is not limited to the above specific embodiment.

In the above embodiment, fuel is burnt in the expansion chamber 4 as a heating means for heating high-pressure gas when a volume of the expansion chamber 4 is expanded by the high-pressure gas supplied into the expansion chamber 4. However, it should be noted that the present invention is not limited to the above specific embodiment and, for example, heating may be conducted from outside the cylinder 2.

In the above embodiment, the reciprocating piston 3 is used as the movable member, however, it should be noted that the present invention is not limited to the above specific embodiment, for example, a triangular rotary piston or a spiral scroll may be used as the movable member.

While the invention has been described by reference to specific embodiments chosen for purposes of illustration, it should be apparent that numerous modifications could be made thereto by those skilled in the art without departing from the basic concept and scope of the invention.

1. An engine driven by high-pressure gas comprising:
a high-pressure gas tank (7) for storing high-pressure gas;
a movable member (3) displaced when pressure is given from the high-pressure gas tank (7) to the movable member (3), the movable member (3) composing an expansion chamber (4) in which the high-pressure gas is expanded;
a crank means for converting a displacement of the movable member (3) into a rotary motion; and
a heating means for heating the high-pressure gas when a volume of the expansion chamber (4) is expanded by the high-pressure gas supplied into the expansion chamber (4).

2. An engine driven by high-pressure gas according to claim 1, wherein the heating means heats the high-pressure gas when fuel is supplied into the expansion chamber (4) and the thus supplied fuel is burnt in the expansion chamber (4).

3. An engine driven by high-pressure gas according to claim 2, wherein a fuel injection port for supplying liquid fuel into the expansion chamber (4) and a high-pressure gas injection port for supplying the high-pressure gas into the expansion chamber (4) are arranged close to each other.

4. An engine driven by high-pressure gas according to claim 2, wherein the high-pressure gas is a compressed fluid containing at least oxygen.

5. An engine driven by high-pressure gas according to claim 4, further comprising an oxidization facilitating device for facilitating oxidization of oxygen supplied into the expansion chamber (4).

6. An engine driven by high-pressure gas according to claim 2, further comprising: a discharge port (5) for discharging gas from the expansion chamber (4); and a valve (6) for opening and closing the discharge port (5), wherein fuel is burnt in the expansion chamber (4) under the condition that the gas discharged from the discharge port (5) is sucked and compressed in the expansion chamber (4).

7. An engine driven by high-pressure gas according to claim 6, wherein the gas discharged from the discharge port (5) is sucked and then compressed.

8. An engine driven by high-pressure gas according to claim 6, wherein after suction of the gas discharged from the discharge port (5) is started, fuel is injected into the expansion chamber (4).

9. An engine driven by high-pressure gas according to claim 8, wherein after fuel was injected into the expansion chamber (4), the high-pressure gas is supplied into the expansion chamber (4).

10. An engine driven by high-pressure gas according to claim 2, further comprising a pressure control means for controlling pressure of the high-pressure gas supplied into the expansion chamber (4), wherein the pressure control means controls an output of the engine.

11. An engine driven by high-pressure gas according to claim 10, further comprising a control device for controlling operation of the pressure control means and the heating means, wherein the control device stops the heating means at the time of start the engine and displaces the movable member by the pressure of the high-pressure gas.

12. An engine driven by high-pressure gas according to claim 1, further comprising a high-pressure gas supplying means (10) for supplying high-pressure gas into the high-pressure gas tank (7) by the power of the crank means when the pressure in the high-pressure gas tank (7) is decreased to a value not more than a predetermined value.

13. An air conditioner applied to a movable body moving by the power of the engine described in claim 12, wherein air blown out into a compartment is heated when high-pressure gas discharged from the high-pressure gas supply means (10) is introduced into the heater (12), and high-pressure gas, from which heat has been emitted, is supplied into the high-pressure gas tank (7) or to the engine.

14. An air conditioner applied to a movable body moving by a power source of the engine described in claim 12, wherein when the engine is operated, the pressure of high-pressure gas discharged from the high-pressure gas supply means (10) is reduced and then introduced into the cooler (13) so as to cool air blown out into a compartment, and when the engine is stopped, the pressure of high-pressure gas supplied from the high-pressure gas tank (7) is reduced and then introduced into the cooler (13) so as to cool air blown out into the compartment, and gas flowed out from the cooler (13) is supplied to the engine.

15. An engine driven by high-pressure gas according to claim 1, wherein the expansion chamber is arranged in an engine body, the expansion chamber includes a piston (3) composing the movable member, a cylinder (2) for accommodating the piston and a gas discharge port connected to an exhaust pipe, the high-pressure gas tank (7) stores gas, the pressure of which is maintained at a value higher than the pressure in the expansion chamber in the case where a volume of the expansion chamber (4) is reduced to the minimum, the high-pressure gas tank (7) is connected to a gas injection device via a pipe, the engine driven by high-pressure gas further comprising:
a valve (6) for opening and closing the discharge port of the expansion chamber;
a fuel tank (9); and
a fuel injection device for injecting fuel from the fuel tank (9) into the expansion chamber (4), wherein
the engine body is started by the pressure of high-pressure gas stored in the high-pressure gas tank (7), and the gas remaining in the exhaust pipe is repeatedly sucked into and compressed by the engine body.

16. An engine driven by high-pressure gas according to claim 15, wherein the catalyst (11) is arranged in the exhaust pipe, after the engine body was started in which the temperature of the catalyst (11) reaches an activating temperature of the catalyst, fuel is injected into the expansion chamber, fuel gas in the expansion chamber is compressed, after the gas remaining in the exhaust pipe is sucked, the process is transferred to the compression stroke, when the piston comes to a position close to the upper dead point, high-pressure gas is supplied into the combustion chamber at the pressure of the high-pressure gas tank which is higher than the pressure in the expansion chamber, and fuel in the expansion chamber is ignited and burnt so as to execute the expansion stroke.

17. An engine driven by high-pressure gas according to claim 16, wherein the piston successively repeats at least an expansion stroke in which expansion is conducted, an exhaust stroke, a suction stroke, a compression stroke and the expansion stroke which are conducted in the expansion chamber.

18. An engine driven by high-pressure gas according to claim 17, wherein a volume of the expansion chamber (4) is expanded by the pressure of high-pressure gas injected by the gas injection device in the expansion stroke, a volume of the expansion chamber (4) is shrunk and the remaining gas is discharged from the discharge port (5) into the exhaust pipe in the exhaust stroke, the remaining gas remaining in the exhaust pipe is sucked from the discharge port (5) in the suction stroke, and the volume of the expansion chamber (4) is reduced and gas, which is sucked or injected into the expansion chamber, is compressed in the compression stroke.

19. An engine driven by high-pressure gas according to claim 17, wherein at the time of operation of the engine conducted after the engine was started, fuel is injected in the middle of the suction stroke or fuel is injected after the process was transferred to the compression stroke, the expansion stroke is composed of an expansion ignition combustion stroke in which high-pressure gas is injected into the expansion chamber by the gas injection device and fuel injected is ignited and burnt,
the exhaust stroke is composed of a stroke in which a volume of the expansion chamber (4) is reduced and the remaining gas is discharged from the discharge port (5) into the exhaust pipe,
the suction stroke is composed of a suction stroke in which the remaining gas remaining in the exhaust pipe is sucked from the discharge port (5), and
the compression stroke is composed of a compression stroke in which gas sucked from or injected into the expansion chamber, the volume of which is reduced, is compressed.

20. An engine driven by high-pressure gas according to claim 19, further comprising a compressor (10) for sucking, compressing and discharging air into a high-pressure gas tank when power is given to the compressor (10) by the engine body, wherein kinetic energy of the vehicle is recovered as pressure energy of high-pressure gas in the case of running on a downward slope or applying the brakes in such a manner that torque of the crank shaft of the engine is transmitted to the compressor (10) under the condition that the discharge port (5) is closed and air pressurized by the compressor (10) is charged into the high-pressure gas tank.

21. An engine driven by high-pressure gas according to claim 19, wherein an output of the engine is adjusted when the pressure of high-pressure gas supplied into the expansion chamber (4) is adjusted.

22. An engine driven by high-pressure gas according to claim 19, further comprising: a compressor (10) for sucking, compressing and discharging air into a high-pressure gas tank so as to charge air into the high-pressure gas tank when power is given to the compressor 10 by the engine body; and a heat exchanger for exchanging heat between the high-pressure gas discharged from the compressor (10) and the atmospheric air so as to cool the high-pressure gas to a temperature approximate to the outside air temperature, wherein high-pressure gas, the temperature of which has been cooled to a temperature approximate to the outside air temperature by the radiator (11), is supplied into the high-pressure gas tank (7) when the high-pressure gas is charged into the high-pressure gas tank (7).

23. An engine driven by high-pressure gas according to claim 19, further comprising a compressor (10) for sucking, compressing and discharging air into a high-pressure gas tank so as to charge air into the high-pressure gas tank when power is given to the compressor (10) by the engine body, wherein the heater is heated by the heat of high-pressure gas which is heated by the compressor (10), and heat exchange is conducted between the heater and the air blown out into the passenger compartment of the vehicle, on which the engine body is mounted, so as to heat the air blown out into the passenger compartment.
